(19) United States
(12) Patent Application Publication
(10) Pub. No.: US 2025/0252947 A1
(43) Pub. Date: Aug. 7, 2025

(54) ACTIVE SOUND EFFECT GENERATING DEVICE AND ACTIVE SOUND EFFECT GENERATING METHOD

(71) Applicant: HONDA MOTOR CO., LTD., Tokyo (JP)

(72) Inventors: Yuma KAEDE, Tokyo (JP); Takanori NIIKURA, Tokyo (JP)

(21) Appl. No.: 19/023,990

(22) Filed: Jan. 16, 2025

(30) Foreign Application Priority Data
Feb. 5, 2024 (JP) 2024-015350

(51) Int. Cl. G10K 15/04

(52) U.S. Cl. CPC G10K 15/04

(57) ABSTRACT

An active sound effect generating device is an active sound effect generating device that causes a speaker to output a sound effect into a cabin of a vehicle driven by a driving source, and is equipped with a signal generating unit that generates a sound effect signal, which is a signal that causes sound effects to be output to the speaker, and an output unit that outputs the sound effect signal generated by the signal generating unit to the speaker, and when it is determined that launch control is in preparation, the signal generating unit generates the sound effect signal that causes the speaker to output a first sound effect having a component of a first frequency as a principal component.

### CROSS-REFERENCE TO RELATED APPLICATIONS

This application is based upon and claims the benefit of priority from Japanese Patent Application No. 2024-015350 filed on Feb. 5, 2024, the contents of which are incorporated herein by reference.

### BACKGROUND OF THE INVENTION

### Field of the Invention

The present disclosure relates to an active sound effect generating device and an active sound effect generating method.

### Description of the Related Art

JP 4395170 B2 discloses a sound effect generating device that generates sound effects from a speaker into a cabin of a vehicle.

### SUMMARY OF THE INVENTION

Better active sound effect generating devices and methods are awaited.

An object of the present invention is to solve the aforementioned problem.

A first aspect of the present disclosure is an active sound effect generating device for causing a speaker to output a sound effect into a cabin of a vehicle driven by a drive source, the active sound effect generating device including: a determination unit that determines, when an operation for activating launch control that enhances acceleration performance during vehicle startup is received, whether the launch control is in preparation; a signal generating unit that generates a sound effect signal that causes the speaker to output the sound effect; and an output unit that outputs the sound effect signal generated by the signal generating unit to the speaker, wherein when the determination unit determines that the launch control is in preparation, the signal generating unit generates the sound effect signal that causes the speaker to output a first sound effect that has a component of a first frequency as a principal component.

A second aspect of the present disclosure is an active sound effect generating method for causing a speaker to output a sound effect into a cabin of a vehicle driven by a driving source, the active sound effect generating method including: a determination step of determining, when an operation for activating launch control that enhances acceleration performance during vehicle startup is received, whether launch control is in preparation; a signal generation step of generating a sound effect signal that causes the speaker to output the sound effect; and an output step of outputting the sound effect signal generated in the signal generation step to the speaker, wherein in a case where it is determined in the determination step that the launch control is in preparation, the sound effect signal that causes the speaker to output a first sound effect having a component of a first frequency as a principal component is generated in the signal generation step.

According to the present invention, a better active sound effect generating device and a better active sound effect generating method can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a functional block diagram of an active sound effect generating device in one embodiment.

FIG. 2 is a functional block diagram of a signal generating unit in one embodiment.

FIG. 3 is an image diagram showing frequency bands of sounds composed of harmonics (harmonic sounds) and frequency bands of background sounds.

FIG. 4 is a graph showing frequency components of an electric motor sound and frequency components of a synthesized sound acquired by synthesizing the electric motor sound and an effect sound.

FIG. 5 is a diagram illustrating sound effects when launch control is activated.

FIG. 6 is a functional block diagram showing a first isolated-sound signal generating unit in one embodiment.

FIG. 7 is a functional block diagram showing a first harmonic-sound signal generating unit in one embodiment.

FIG. 8 is a functional block diagram showing a first background-sound signal generating unit in one embodiment.

FIG. 9 is a flowchart of a sound effect generation process performed in the active sound effect generating device in one embodiment.

### DETAILED DESCRIPTION OF THE INVENTION

There has not been proposed an active sound effect generating device capable of outputting into a cabin a sound effect that gives a driver a sense of exhilaration when launch control is activated that enhances acceleration performance during vehicle startup.

An active sound effect generating device of the present disclosure can output into a cabin a sound effect that gives a driver a sense of exhilaration when launch control is activated.

### One Embodiment

### Configuration of Active Sound Effect Generating Device

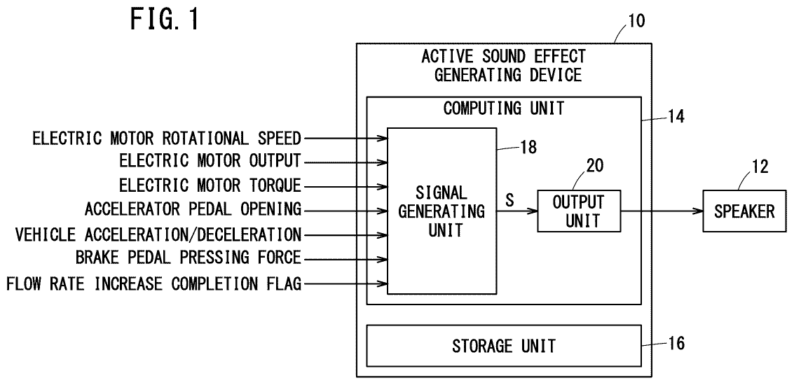

FIG. 1 is a functional block diagram of an active sound effect generating device 10 in one embodiment. The active sound effect generating device 10 is installed in a vehicle driven by an electric motor. Vehicles driven by the electric motor are BEVs (Battery Electric Vehicles), HEVs (Hybrid Electric Vehicles), PHEVS (plug-in Hybrid Electric Vehicles), FCEVs (Fuel Cell Electric Vehicles), etc.

An active sound effect generating device 10 outputs sound effects from a speaker 12 provided in a cabin of an electric vehicle. The sound effects enhance the attractiveness of the electric vehicle to occupants.

The active sound effect generating device 10 includes a computing unit 14 and a storage unit 16. The computing unit 14 is a processor such as a CPU (Central Processing Unit), a GPU (Graphics Processing Unit), or the like.

The computing unit 14 functions as a signal generating unit 18 and an output unit 20. The signal generating unit 18 and the output unit 20 are realized by the computing unit 14 executing programs stored in the storage unit 16.

At least part of the signal generating unit 18 and the output unit 20 may be realized by an integrated circuit such as an ASIC (Application Specific Integrated Circuit), an FPGA (Field-Programmable Gate Array), etc. At least part of the signal generating unit 18 and the output unit 20 may be realized by an electronic circuit including a discrete device.

The storage unit 16 is composed of a volatile memory (not shown) and a non-volatile memory (not shown), which are computer-readable storage media. The volatile memory is, for example, RAM (Random Access Memory) or the like. The nonvolatile memory is, for example, ROM (Read Only Memory), flash memory, or the like. Data or the like are stored, for example, in volatile memory. Programs, tables, maps, or the like are stored, for example, in non-volatile memory.

At least part of the storage unit 16 may be provided in the above-mentioned processor, integrated circuit, or the like. At least part of the storage unit 16 may be installed in a device connected to the active sound effect generating device 10 through a network.

The signal generating unit 18 generates a sound effect signal S that causes the speaker 12 to output a sound effect. The output unit 20 outputs to the speaker 12 the sound effect signal S generated by the signal generating unit 18. The speaker 12 generates a sound effect in the cabin in accordance with the sound effect signal S.

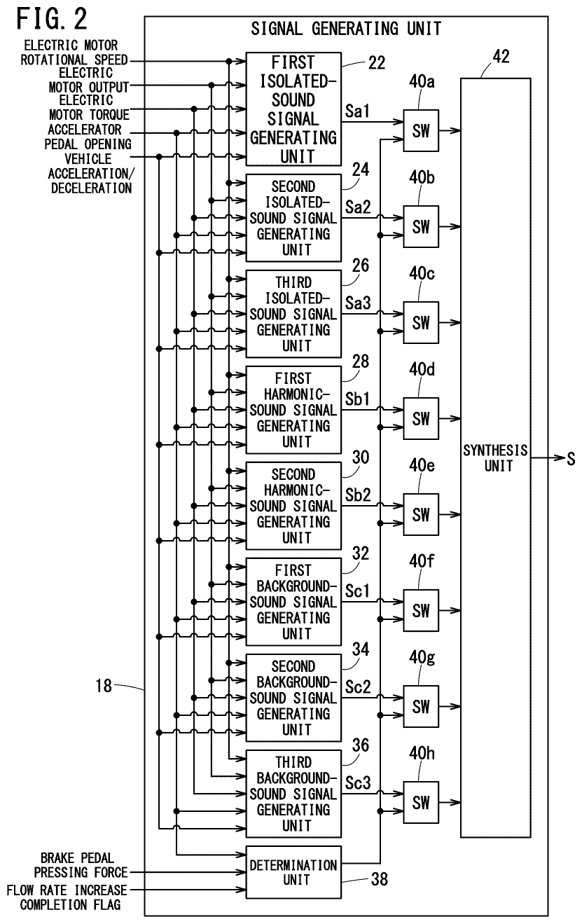

FIG. 2 is a functional block diagram of a signal generating unit 18 in one embodiment. The signal generating unit 18 includes a first isolated-sound signal generating unit 22, a second isolated-sound signal generating unit 24, a third isolated-sound signal generating unit 26, a first harmonic-sound signal generating unit 28, a second harmonic-sound signal generating unit 30, a first background-sound signal generating unit 32, a second background-sound signal generating unit 34, a third background-sound signal generating unit 36, a determination unit 38, selection switches 40a to 40h, and a synthesis unit 42.

The first isolated-sound signal generating unit 22, the second isolated-sound signal generating unit 24, and the third isolated-sound signal generating unit 26 generate isolated-sound signals that are electric signals for causing the speaker 12 to output isolated sounds that change according to the state of the launch control. The state of launch control will be detailed later.

The first isolated-sound signal generating unit 22 generates a first isolated-sound signal Sa1. The first isolated-sound signal Sa1 is a signal of a sound whose principal component is a relatively low frequency f1. The frequency f1 corresponds to a first frequency of the present invention. The sound whose principal component is the frequency f1 indicates that the amplitude of the sound at the frequency f1 is the largest. The selection switch 40a switches between a state (ON) in which the first isolated-sound signal Sa1 is output to the synthesis unit 42 and a state (OFF) in which the first isolated-sound signal Sa1 is not output to the synthesis unit 42. In the following, an isolated sound whose principal component is the frequency f1 may be described as a first isolated sound or a first sound effect. When the state of the launch control is “in preparation”, the first isolated sound is output from the speaker 12 into the vehicle.

The second isolated-sound signal generating unit 24 generates a second isolated-sound signal Sa2. The second isolated-sound signal Sa2 is a signal of a sound whose principal component is a frequency f2 higher than the frequency f1. The frequency f2 corresponds to a second frequency of the present invention. The sound whose principal component is the frequency f2 indicates that the amplitude of the sound at the frequency f2 is the largest. The selection switch 40b switches between a state (ON) in which the second isolated-sound signal Sa2 is output to the synthesis unit 42 and a state (OFF) in which the second isolated-sound signal Sa2 is not output to the synthesis unit 42. In the following, an isolated sound whose principal component is the frequency f2 may be described as a second isolated sound or a second sound effect. When the launch control state is “ready”, the second isolated sound is output from the speaker 12 into the vehicle.

The third isolated-sound signal generating unit 26 generates a third isolated-sound signal Sa3. The third isolated-sound signal Sa3 is a signal of a sound whose principal component is a frequency f3 that is different from the frequency f1 and the frequency f2. The frequency f3 corresponds to a third frequency of the present invention. The sound whose principal component is the frequency f3 indicates that the amplitude of the sound at the frequency f3 is the largest. The selection switch 40c switches between a state (ON) in which the third isolated-sound signal Sa3 is output to the synthesis unit 42 and a state (OFF) in which the third isolated-sound signal Sa3 is not output to the synthesis unit 42. In the following, an isolated sound whose principal component is the frequency f3 may be described as a third isolated sound or a third sound effect. When the state of the launch control is “in operation”, the third isolated sound is output from the speaker 12 into the vehicle.

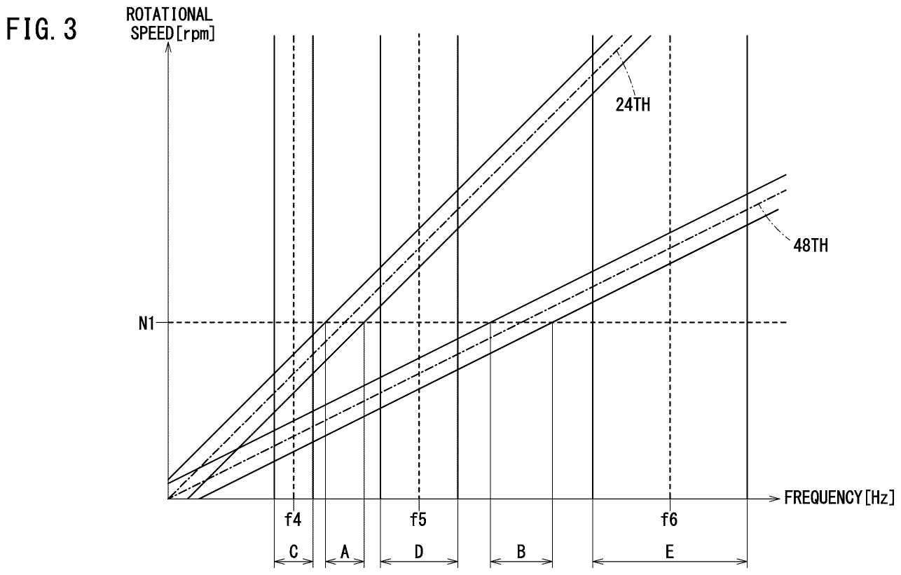

The first harmonic-sound signal generating unit 28 and the second harmonic-sound signal generating unit 30 generate harmonic-sound signals, which are electric signals that cause the speaker 12 to output harmonic sounds that change in conjunction with the variation of the rotational speed of the electric motor. The first background-sound signal generating unit 32, the second background-sound signal generating unit 34, the third background-sound signal generating unit 36 generate background-sound signals, which are electric signals that cause the speaker 12 to output background sounds that are not linked with the variation of the rotational speed of the electric motor. FIG. 3 is an image diagram showing frequency bands of sounds composed of harmonics (harmonic sounds) and frequency bands of background sounds.

The first harmonic-sound signal generating unit 28 generates a first harmonic-sound signal Sb1. The first harmonic-sound signal Sb1 is a signal of a sound composed of a plurality of frequency components in a frequency band having a predetermined range centered on the 24th harmonic frequency of the rotational speed of the electric motor.

The sound composed of a plurality of frequency components in a frequency band having a predetermined range centered on the 24th harmonic frequency of the rotational speed of the electric motor means a sound in which the center of the frequency band is the 24th harmonic frequency of the rotational speed of the electric motor. Therefore, the amplitude of the sound of the 24th harmonic frequency of the rotational speed of the electric motor may be smaller than the amplitudes of the sounds of other frequencies.

In FIG. 3, a frequency band having a predetermined range centered on the 24th harmonic frequency of a rotational speed N1 [rpm] of the electric motor is shown as a band A. The selection switch 40d switches between a state (ON) in which the first harmonic-sound signal Sb1 is output to the synthesis unit 42 and a state (OFF) in which the first harmonic-sound signal Sb1 is not output to the synthesis unit 42. In the following, a sound composed of a plurality of frequency components in a frequency band having a predetermined range centered on the 24th harmonic frequency of the rotational speed of the electric motor may be referred to as a first harmonic sound.

The second harmonic-sound signal generating unit 30 generates a second harmonic-sound signal Sb2. The second harmonic-sound signal Sb2 is a signal of a sound composed of a plurality of frequency components in a frequency band having a predetermined range centered on the 48th harmonic frequency of the rotational speed of the electric motor.

The sound composed of a plurality of frequency components in a frequency band having a predetermined range centered at the 48th harmonic frequency of the rotational speed of the electric motor means a sound in which the center of the frequency band is the 48th harmonic frequency of the rotational speed of the electric motor. Therefore, the amplitude of the sound of the 48th harmonic frequency of the rotational speed of the electric motor may be smaller than the amplitudes of the sounds of other frequencies.

In FIG. 3, a frequency band having a predetermined range centered on the 48th harmonic frequency of the rotational speed N1 [rpm] of the electric motor is shown as a band B. The selection switch 40b switches between a state (ON) in which the second harmonic-sound signal Sb2 is output to the synthesis unit 42 and a state (OFF) in which the second harmonic-sound signal Sb2 is not output to the synthesis unit 42. In the following, a sound composed of a plurality of frequency components in a frequency band having a predetermined range centered on the 48th harmonic frequency of the rotational speed of the electric motor may be referred to as a second harmonic sound. In the following, both the first harmonic sound and the second harmonic sound may be referred to as a fourth effect sound.

The first background-sound signal generating unit 32 generates a first background-sound signal Sc1. The first background-sound signal Sc1 is a signal of a sound composed of a plurality of frequency components in a frequency band having a predetermined range centered on a frequency f4.

The sound composed of a plurality of frequency components in a frequency band having a predetermined range centered on the frequency f4 means a sound in which the center of the frequency band is the frequency f4. Therefore, the amplitude of the sound of the frequency f4 may be smaller than the amplitudes of the sounds of other frequencies.

In FIG. 3, a frequency band of a predetermined range centered on the frequency f4 is shown as a band C. The selection switch 40f switches between a state (ON) in which the first background-sound signal Sc1 is output to the synthesis unit 42 and a state (OFF) in which the first background-sound signal Sc1 is not output to the synthesis unit 42. In the following, a sound composed of a plurality of frequency components in a frequency band having a predetermined range centered on the frequency f4 may be referred to as a first background sound.

The second background-sound signal generating unit 34 generates a second background-sound signal Sc2. The second background-sound signal Sc2 is a signal of a sound composed of a plurality of frequency components in a frequency band having a predetermined range centered on a frequency f5.

The sound composed of a plurality of frequency components in a frequency band having a predetermined range centered on the frequency f5 means a sound in which the center of the frequency band is the frequency f5. Therefore, the amplitude of the sound of the frequency f5 may be smaller than the amplitudes of the sounds of other frequencies.

In FIG. 3, a frequency band of a predetermined range centered on the frequency f5 is shown as a band D. The selection switch 40g switches between a state (ON) in which the second background-sound signal Sc2 is output to the synthesis unit 42 and a state (OFF) in which the second background-sound signal Sc2 is not output to the synthesis unit 42. A sound composed of a plurality of frequency components in a frequency band having a predetermined range centered on the frequency f5 may be referred to as a second background sound.

The third background-sound signal generating unit 36 generates a third background-sound signal Sc3. The third background-sound signal Sc3 is a signal of a sound composed of a plurality of frequency components in a frequency band having a predetermined range centered on a frequency f6.

The sound composed of a plurality of frequency components in a frequency band having a predetermined range centered on the frequency f6 means a sound in which the center of the frequency band is the frequency f6. Therefore, the amplitude of the sound of the frequency f6 may be smaller than the amplitudes of the sounds of other frequencies.

In FIG. 3, a frequency band of a predetermined range centered on the frequency f6 is shown as a band E. The selection switch 40h switches between a state (ON) in which the third background-sound signal Sc3 is output to the synthesis unit 42 and a state (OFF) in which the third background-sound signal Sc3 is not output to the synthesis unit 42. A sound composed of a plurality of frequency components in a frequency band having a predetermined range centered on the frequency f6 may be referred to as a third background sound.

The synthesis unit 42 generates the sound effect signal S based on the first isolated-sound signal Sa1, the second isolated-sound signal Sa2, the third isolated-sound signal Sa3, the first harmonic-sound signal Sb1, the second harmonic-sound signal Sb2, the first background-sound signal Sc1, the second background-sound signal Sc2, and the third background-sound signal Sc3.

The determination unit 38 determines the state of the launch control. As the state of the launch control, four states are determined: “deactivated”, “in preparation”, “ready”, and “in operation”. The state of the launch control is determined based on an accelerator pedal opening, brake pedal pressing force, and a coolant flow rate increase completion flag. The determination of the state of the launch control will be detailed later.

Each of the selection switches 40a to 40h is switched depending on the state of the launch control. The sound effect output from the speaker 12 can be changed by switching each of the selection switches 40a to 40h.

### Harmonic Sounds and Background Sounds

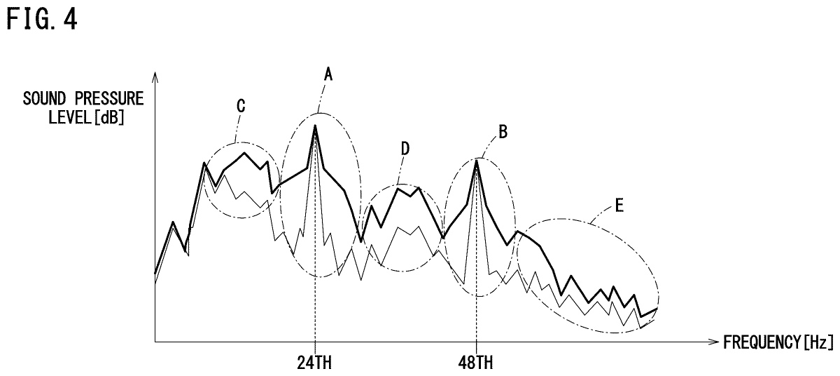

When the electric motor rotates, a synthesized sound composed of the first harmonic sound, the second harmonic sound, the first background sound, the second background sound, and the third background sound is output from the speaker 12 into the vehicle as a sound effect. FIG. 4 is a graph showing frequency components of an electric motor sound and frequency components of a synthesized sound acquired by synthesizing the electric motor sound and an effect sound. A thin line graph in FIG. 4 indicates the frequency components of the electric motor sound whereas a thick line graph indicates the frequency components of the synthesized sound. FIG. 4 shows the frequency components when the electric motor is at the rotational speed N1 (see FIG. 3). The electric motor sound is not limited to the sound generated by the electric motor itself. The electric motor sound may include a sound generated by a gear rotating in synchronization with the electric motor.

As shown by the fine line graph in FIG. 4, the sound pressure level of the 24th harmonic frequency component of the electric motor sound and the sound pressure level of the 48th harmonic frequency component of the electric motor sound are prominent compared to the sound pressure levels of the other frequency components of the electric motor sound. Therefore, the sound of the 24th harmonic frequency component and the sound of the 48th harmonic frequency component are heard noticeably by the occupant of the vehicle, giving the occupant a sense of discomfort. Therefore, the first harmonic sound and the second harmonic sound are generated from the speaker 12, whereby the sound pressure level of the component in the frequency band having the predetermined range centered on the 24th harmonic frequency and the sound pressure level of the component in the frequency band having the predetermined range centered on the 48th harmonic frequency are increased (see the parts indicated by A and B in FIG. 4). In this way, a synthesized sound can be generated that is linked to the fluctuation of the rotational speed of the electric motor and alleviates the prominence of the sound of the 24th harmonic frequency component and the sound of the 48th harmonic frequency component.

The order of the frequency component of the outstanding sound pressure level varies depending on electric motor specifications, transmission specifications, powertrain specifications, or the like. Therefore, the order of the frequency component of the outstanding sound pressure level is not limited to the 24th or 48th. In addition, the number of points where the sound pressure levels stand out varies depending on the electric motor specifications, the transmission specifications, the powertrain specifications, or the like. Therefore, the points where the sound pressure levels stand out are not limited to two points (24th, 48th). For example, when the sound pressure levels are prominent at three locations, a third harmonic-sound signal generating unit (not shown) may be provided in the signal generating unit 18 in addition to the first harmonic-sound signal generating unit 28 and the second harmonic-sound signal generating unit 30 shown in FIG. 2.

In addition, a vehicle body may resonate with the electric motor sound, and the sound pressure level of the component of the resonant frequency of the vehicle body may stand out from the sound pressure levels of the other frequency components. Therefore, the first, second, and third background sounds are generated from the speaker 12, whereby the sound pressure levels of the components in a frequency band having a predetermined range centered on the resonant frequency of the vehicle body are increased (see the portions indicated by C, D, and E in FIG. 4). Thus, the synthesized sound can be made where the prominence of the resonant sound has been alleviated.

Because the resonance frequency varies with the vehicle body, the center frequencies of the first background sound, the second background sound, and the third background sound are adjusted and determined for each vehicle body. Further, because the number of resonant frequencies also varies with the vehicle body, the background sound is not limited to three types of the first background sound, the second background sound, and the third background sound but may be two or less types of background sound or four or more types of background sound. For example, when the types of background sound are two, it is ensured that a state in which the third background sound is not output to the synthesis unit 42 is selected by the selection switch 40h shown in FIG. 2. For example, when the types of background sound are four, a fourth background-sound signal generating unit (not shown) may be provided in the signal generating unit 18 in addition to the first background-sound signal generating unit 32, the second background-sound signal generating unit 34, and the third background-sound signal generating unit 36 shown in FIG. 1.

When the electric motor rotates, a synthesized sound of the first harmonic sound and the second harmonic sound may be output from the speaker 12 into the vehicle as a sound effect. That is, the background sound need not be included in the sound effect.

### Sound Effects when Launch Control is Activated

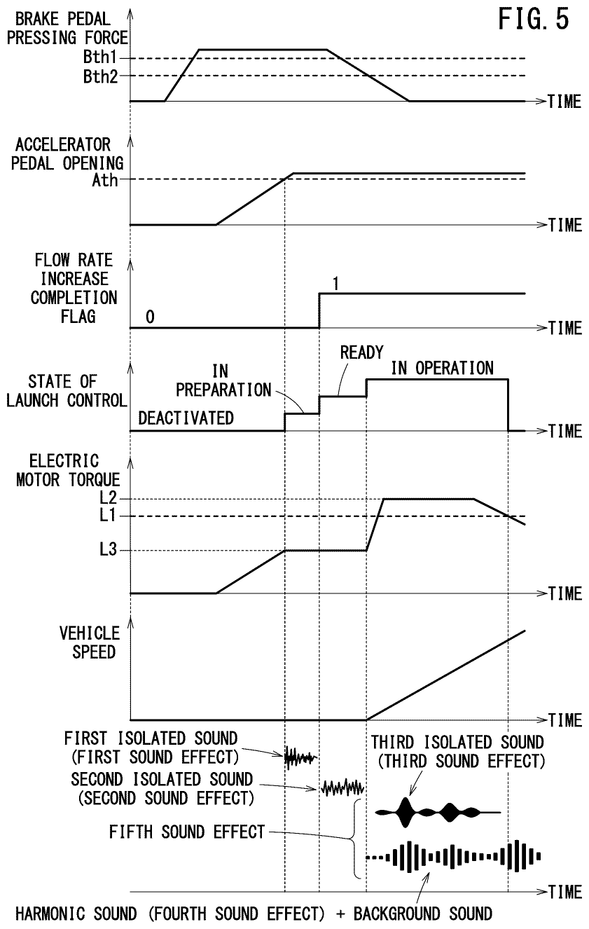

FIG. 5 is a diagram illustrating sound effects when launch control is activated. FIG. 5 shows, from the top, a time chart of brake pedal pressing force, a time chart of accelerator pedal opening, a time chart of flow rate increase completion flag, a time chart of launch control state, a time chart of electric motor torque, and a time chart of vehicle speed.

Launch control enhances the acceleration performance of a vehicle during vehicle startup by the electric motor outputting higher torque than usual while the slip of the driving wheels is suppressed. When the launch control is not activated, i.e., in normal conditions, the torque of the electric motor during vehicle startup is limited to a limit L1. On the other hand, when the launch control is activated, the torque of the electric motor during vehicle startup is allowed up to a limit L2, which is higher than the limit L1. While the vehicle is stopped, the torque of the electric motor is limited to a limit L3. The limit L3 is a torque limit value when the driver simultaneously depresses the brake pedal and the accelerator pedal.

While the vehicle is stopped, if the driver simultaneously depresses the brake pedal and the accelerator pedal, launch control preparation is initiated. When the launch control preparation is started, the flow rate of the cooling water for cooling the electric motor is increased more than usual. While launch control is in operation, the electric motor produces higher torque than usual, resulting in that the heat generation of the electric motor increases. Therefore, the cooling performance of the electric motor is enhanced by increasing the flow rate of the cooling water. When the increase of the flow rate of the cooling water is completed, the flow rate increase completion flag is switched from “0” to “1”. When the driver then eases off the brake pedal, launch control is activated and the vehicle starts moving. When launch control is activated, the electric motor can produce higher torque than usual, resulting in that the acceleration performance during vehicle startup improves compared to the normal conditions in which launch control is not activated.

When the brake pedal pressing force is equal to or greater than a threshold value Bth1 and the accelerator pedal opening is equal to or greater than a threshold value Ath, the determination unit 38 determines that the state of launch control is “in preparation”. When the brake pedal pressing force is less than the threshold Bth1 or the accelerator pedal opening is less than the threshold Ath, the determination unit 38 determines that the state of launch control is “deactivated”.

When the flow rate increase completion flag becomes “1” in a state where the brake pedal pressing force is equal to or greater than the threshold value Bth1 and the accelerator pedal opening is equal to or greater than the threshold value Ath, the determination unit 38 determines that the state of launch control is “ready”. When the brake pedal pressing force becomes equal to or less than the threshold Bth2 after “ready”, the determination unit 38 determines that the state of launch control is “in operation”. When a predetermined time has elapsed since the state of launch control was determined to be “in operation”, the determination unit 38 determines that the state of launch control is “deactivated”.

When the state of launch control is determined to be “in preparation”, the first isolated sound (first sound effect) is output from the speaker 12. The first isolated sound is a sound having a component of relatively low frequency f1 as a principal component. This makes the driver feel the increasing torque.

When the state of launch control is determined to be “ready”, the second isolated sound (second sound effect) is output from the speaker 12. The second isolated sound is a sound having a component of frequency f2, which is higher than frequency f1, as a principal component. Switching from the first sound effect to the second sound effect allows the driver to recognize that launch control is ready and the vehicle can be started at high acceleration if the driver eases off the brake. In addition, by outputting a sound with a relatively high frequency from the speaker 12, it is possible to simulate a state in which a high engine rotational speed is maintained in an engine vehicle.

When the state of launch control is determined to be “in operation”, a third isolated sound (third effect sound) is output from the speaker 12. When the state of launch control is “in operation”, the electric motor is rotating and thus the harmonic sound (fourth sound effect) and the background sound are output from the speaker 12. That is, a synthesized sound acquired by synthesizing the third isolated sound, the harmonic sound, and the background sound is output from the speaker 12. In the following, the synthesized sound acquired by synthesizing the third isolated sound, the harmonic sound, and the background sound may be described as the fifth sound effect.

Thus, a synthesized sound in which the third isolated sound is synthesized in addition to the harmonic sound and the background sound that are output in the normal conditions is output from the speaker 12, and thus the driver can be made to recognize that the acceleration different from the normal is performed. For example, the frequency f3 of the sound that is the principal component of the third isolated sound is made close to the frequency of the wind noise of the vehicle, whereby it is possible to give the driver a sense of acceleration.

### Configuration of Isolated-Sound Signal Generating Unit

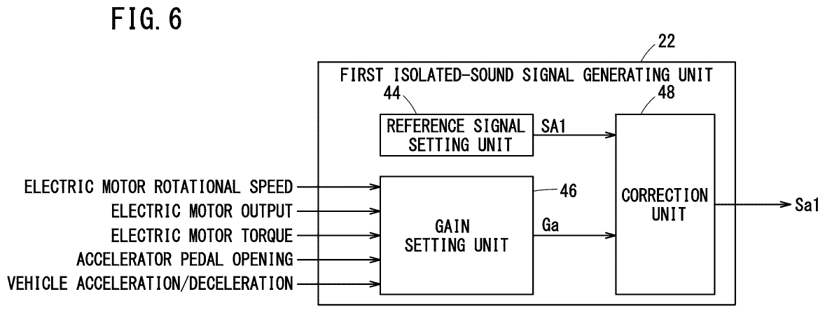

FIG. 6 is a functional block diagram showing a first isolated-sound signal generating unit 22 in one embodiment. The first isolated-sound signal generating unit 22 includes a reference signal setting unit 44, a gain setting unit 46, and a correction unit 48.

The reference signal setting unit 44 sets a reference signal SA1. The reference signal SA1 is a sound signal having a component of frequency f1 as a principal component.

The gain setting unit 46 sets a gain Ga. The gain Ga is set according to the rotational speed of the electric motor, the output of the electric motor, the torque of the electric motor, the opening degree of the accelerator pedal, and the acceleration/deceleration of the vehicle.

The correction unit 48 outputs a first isolated-sound signal Sa1 obtained by multiplying the reference signal SA1 set by the reference signal setting unit 44 by the gain Ga.

The second isolated-sound signal generating unit 24 is different from the first isolated-sound signal generating unit 22 in that the reference signal set by the reference signal setting unit 44 is a sound signal having a component of the frequency f2 as a principal component, but the other configuration is the same as that of the first isolated-sound signal generating unit 22.

The third isolated-sound signal generating unit 26 is different from the first isolated-sound signal generating unit 22 in that the reference signal set by the reference signal setting unit 44 is a sound signal having a component of the frequency f3 as a principal component, but the other configuration is the same as that of the first isolated-sound signal generating unit 22.

### Configuration of Harmonic-Sound Signal Generating Unit

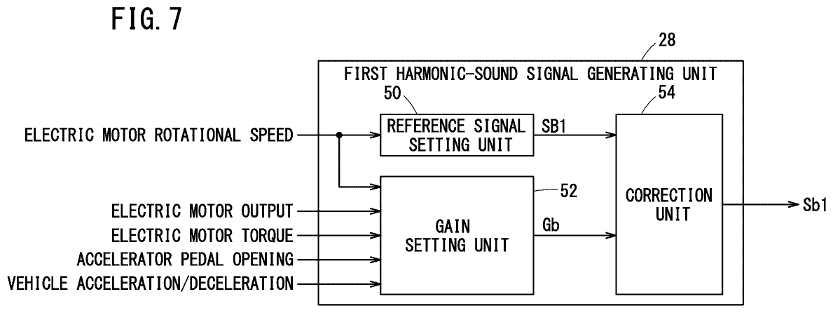

FIG. 7 is a functional block diagram showing a first harmonic-sound signal generating unit 28 in one embodiment. The first harmonic-sound signal generating unit 28 includes a reference signal setting unit 50, a gain setting unit 52, and a correction unit 54.

The reference signal setting unit 50 sets the reference signal SB1 based on the rotational speed of the electric motor. The reference signal SB1 is a sound signal composed of a plurality of frequency components in a frequency band having a predetermined range centered on the 24th harmonic frequency of the rotational speed of the electric motor.

The gain setting unit 52 sets a gain Gb. The gain Gb is set according to the rotational speed of the electric motor, the output of the electric motor, the torque of the electric motor, the opening degree of the accelerator pedal, and the acceleration/deceleration of the vehicle.

The correction unit 54 outputs a first harmonic-sound signal Sb1 obtained by multiplying the reference signal SB1 set by the reference signal setting unit 50 by the gain Gb.

The second harmonic-sound signal generating unit 30 is different from the first harmonic-sound signal generating unit 28 in that the reference signal set by the reference signal setting unit 50 is a sound signal composed of a plurality of frequency components in a frequency band having a predetermined range centered on the 48th harmonic frequency of the rotational speed of the electric motor, but the other configuration is the same as that of the first harmonic-sound signal generating unit 28.

### Configuration of Background-Sound Signal Generating Unit

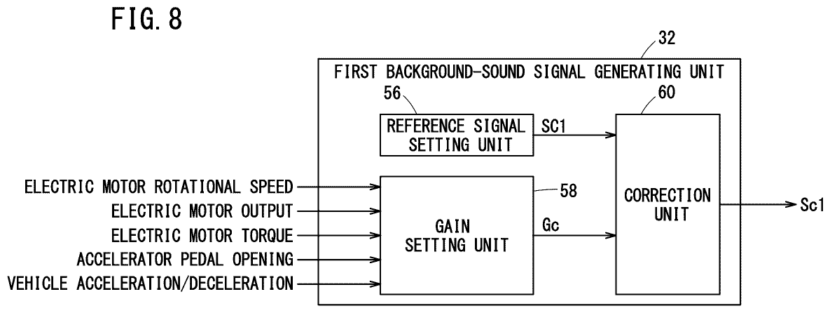

FIG. 8 is a functional block diagram showing the first background-sound signal generating unit 32 in one embodiment. The first background-sound signal generating unit 32 includes a reference signal setting unit 56, a gain setting unit 58, and a correction unit 60.

The reference signal setting unit 56 sets a reference signal SC1. The reference signal SC1 is a sound signal composed of a plurality of frequency components in a frequency band whose center frequency is the frequency f4.

The gain setting unit 58 sets a gain Gc. The gain Gc is set according to the rotational speed of the electric motor, the output of the electric motor, the torque of the electric motor, the opening degree of the accelerator pedal, and the acceleration/deceleration of the vehicle.

The correction unit 60 outputs the first background-sound signal Sc1 obtained by multiplying the reference signal SC1 set by the reference signal setting unit 56 by the gain Gc.

The second background-sound signal generating unit 34 is different from the first background-sound signal generating unit 32 in that the reference signal set by the reference signal setting unit 56 is a sound signal composed of a plurality of frequency components in a frequency band whose center frequency is the frequency f5, but the other configuration is the same as that of the first background-sound signal generating unit 32.

The third background-sound signal generating unit 36 is different from the first background-sound signal generating unit 32 in that the reference signal set by the reference signal setting unit 56 is a sound signal composed of a plurality of frequency components in a frequency band whose center frequency is the frequency f6, but the other configuration is the same as that of the first background-sound signal generating unit 32.

### Sound Effect Generation Process

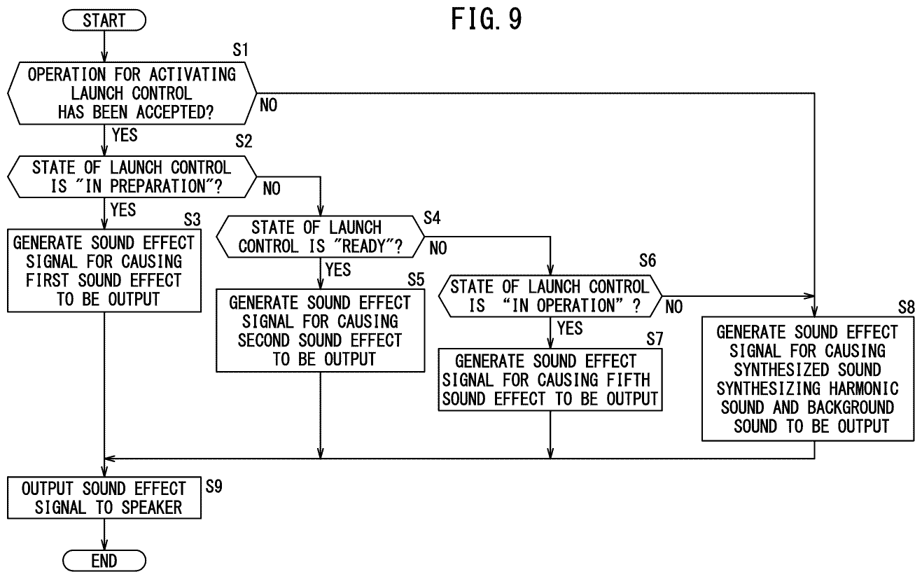

FIG. 9 is a flowchart of a sound effect generation process performed in the active sound effect generating device 10 in the present embodiment. The sound effect generation process is repeatedly executed at a predetermined cycle while the vehicle is activated.

In step S1, the determination unit 38 determines whether or not an operation for activating the launch control has been accepted. The operation to activate the launch control refers to the operation in which the driver simultaneously depresses the brake pedal and the accelerator pedal.

When it is determined in step S1 that an operation for activating the launch control has been accepted (step S1: YES), the process proceeds to step S2. In step S2, the determination unit 38 determines whether the state of the launch control is “in preparation”.

If it is determined in step S2 that the state of the launch control is “in preparation” (step S2: YES), the process proceeds to step S3. In step S3, the determination unit 38 turns the selection switch 40a to “ON” and turns each of the selection switches 40b to 40h to “OFF”. Thus, only the first isolated-sound signal Sa1 is input to the synthesis unit 42, and the same sound effect signal S as the first isolated-sound signal Sa1 is generated in the synthesis unit 42. That is, the sound effect signal S is generated for causing the first isolated sound (first sound effect) to be output from the speaker 12. Then, the process proceeds to step S9.

If it is determined in step S2 that the state of the launch control is not “in preparation” (step S2: NO), the process proceeds to step S4. In step S4, the determination unit 38 determines whether the state of the launch control is “ready”.

When it is determined in step S4 that the state of the launch control is “ready” (step S4: YES), the process proceeds to step S5. In step S5, the determination unit 38 turns the selection switch 40b to “ON” and turns each of the selection switches 40a, 40c to 40h to “OFF”. Thus, only the second isolated-sound signal Sa2 is input to the synthesis unit 42, and the same sound effect signal S as the second isolated-sound signal Sa2 is generated in the synthesis unit 42. That is, the sound-effect signal S is generated for causing the second isolated sound (second sound effect) to be output from the speaker 12. Then, the process proceeds to step S9.

If it is determined in step S4 that the state of the launch control is not “ready” (step S4: NO), the process proceeds to step S6. In step S6, the determination unit 38 determines whether the state of the launch control is “in operation”.

If it is determined in step S6 that the state of the launch control is “in operation” (step S6: YES), the process proceeds to step S7. In step S7, the determination unit 38 turns “ON” each of the selection switches 40c to 40h and turns “OFF” each of the selection switches 40a, 40b. In this way, the third isolated-sound signal Sa3, the first harmonic-sound signal Sb1, the second harmonic-sound signal Sb2, the first background-sound signal Sc1, the second background-sound signal Sc2, and the third background-sound signal Sc3 are input to the synthesis unit 42. The synthesis unit 42 generates a sound effect signal S as a signal obtained by synthesizing the third isolated-sound signal Sa3, the first harmonic-sound signal Sb1, the second harmonic-sound signal Sb2, the first background-sound signal Sc1, the second background-sound signal Sc2, and the third background-sound signal Sc3. That is, the sound-effect signal S is generated to output from the speaker 12 a synthesized sound (fifth sound effect) acquired by synthesizing the third isolated sound, the first harmonic sound, the second harmonic sound, the first background sound, the second background sound, and the third background sound. Then, the process proceeds to step S9.

If it is determined in step S1 that the operation for activating the launch control has not been accepted (step S1: NO), the process proceeds to step S8. When it is determined in step S6 that the state of the launch control is not “in operation” (step S6: NO), the process proceeds to step S8.

In step S8, the determination unit 38 turns each of the selection switches 40d to 40h to “ON” and turns each of the selection switches 40a to 40c to “OFF”. In this way, the first harmonic-sound signal Sb1, the second harmonic-sound signal Sb2, the first background-sound signal Sc1, the second background-sound signal Sc2, and the third background-sound signal Sc3 are input to the synthesis unit 42. The synthesis unit 42 generates the sound effect signal S as a signal obtained by synthesizing the first harmonic-sound signal Sb1, the second harmonic-sound signal Sb2, the first background-sound signal Sc1, the second background-sound signal Sc2, and the third background-sound signal Sc3. That is, the sound effect signal S is generated that causes a synthesized sound acquired by synthesizing the first harmonic sound, the second harmonic sound, the first background sound, the second background sound, and the third background sound to be output from the speaker 12. Then, the process proceeds to step S9.

In step S9, the output unit 20 outputs the sound effect signal S to the speaker 12. Thus, the sound effect is output from the speaker 12 to the cabin. Then, the sound effect generation process is terminated.

With respect to the above embodiments, the following supplementary notes are further disclosed.

### Supplemental Note 1

An active sound effect generating device (10) of the present disclosure is an active sound effect generating device for causing a speaker (12) to output a sound effect into a cabin of a vehicle driven by a driving source, including: a determination unit (38) that determines, when an operation for activating launch control that enhances acceleration performance during vehicle startup is received, whether the launch control is in preparation; a signal generating unit (18) that generates a sound effect signal that causes the speaker to output the sound effect, and an output unit (20) that outputs the sound effect signal generated by the signal generating unit to the speaker, wherein when the determination unit determines that the launch control is in preparation, the signal generating unit generates the sound effect signal that causes the speaker to output a first sound effect having a component of a first frequency as a principal component.

### Supplemental Note 2

In the active sound effect generating device according to Supplementary note 1, the determination unit may further determine whether preparation of the launch control is completed, and the signal generating unit may generate, when the determining unit determines that the preparation of the launch control is completed, the sound effect signal that causes the speaker to output a second sound effect having, as a principal component, a component of a second frequency higher than the first frequency.

### Supplemental Note 3

In the active sound effect generating device according to Supplementary note 2, the determination unit may further determine whether the launch control is in operation, and the signal generating unit may generate, when the determining unit determines that the launch control is in operation, the sound effect signal that causes the speaker to output a third sound effect having, as a principal component, a component of a third frequency different from any of the first frequency and the second frequency.

### Supplemental Note 4

In the active sound effect generating device according to Supplementary note 2, the determination unit may further determine whether the launch control is in operation, and the signal generating unit may generate, when the determination unit determines that the launch control is in operation, the sound effect signal that causes the speaker to output a fifth sound effect acquired by synthesizing a third sound effect having, as a principal component, a component of a third frequency different from any of the first frequency and the second frequency, and a fourth sound effect that changes according to a rotational speed of the driving source.

### Supplemental Note 5

An active sound effect generating method of the present disclosure is an active sound effect generating method for causing a speaker to output a sound effect into a cabin of a vehicle driven by a driving source, and the active sound effect generating method includes: a determination step of determining, when an operation for activating launch control that enhances acceleration performance during vehicle startup is received, whether the launch control is in preparation; a signal generation step of generating a sound effect signal that causes the speaker to output the sound effect; and an output step of outputting the sound effect signal generated in the signal generation step to the speaker, wherein in a case where it is determined in the determination step that the launch control is in preparation, in the signal generation step the sound effect signal is generated that causes the speaker to output a first sound effect having a component of a first frequency as a principal component.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. An active sound effect generating device for causing a speaker to output a sound effect into a cabin of a vehicle driven by a driving source, the active sound effect generating device comprising:
one or more processors that execute computer-executable instructions stored in a memory, wherein the one or more processors execute the computer-executable instructions to cause the active sound effect generating device to:
determine, when an operation for activating launch control that enhances acceleration performance during vehicle startup is received, whether the launch control is in preparation;
generate a sound effect signal that causes the speaker to output a first sound effect having a component of a first frequency as a principal component when it is determined that the launch control is in preparation; and
output to the speaker the sound effect signal that has been generated.

2. The active sound effect generating device according to claim 1, wherein
the one or more processors causes the active sound effect generating device further to:
determine whether preparation of the launch control is completed; and
generate, when it is determined that the preparation of the launch control is completed, the sound effect signal that causes the speaker to output a second sound effect having, as a principal component, a component of a second frequency higher than the first frequency.

3. The active sound effect generating device according to claim 2, wherein
the one or more processors causes the active sound effect generating device further to:
determine whether the launch control is in operation; and
generate, when it is determined that the launch control is in operation, the sound effect signal that causes the speaker to output a third sound effect having, as a principal component, a component of a third frequency different from any of the first frequency and the second frequency.

4. The active sound effect generating device according to claim 2, wherein
the one or more processors causes the active sound effect generating device further to:
determine whether the launch control is in operation; and
generate, when it is determined that the launch control is in operation, the sound effect signal that causes the speaker to output a fifth sound effect acquired by synthesizing a third sound effect having, as a principal component, a component of a third frequency different from any of the first frequency and the second frequency, and a fourth sound effect that changes according to a rotational speed of the driving source.

5. An active sound effect generating method for causing a speaker to output a sound effect into a cabin of a vehicle driven by a driving source, the active sound effect generating method comprising:
determining, when an operation for activating launch control that enhances acceleration performance during vehicle startup is received, whether the launch control is in preparation;
generating a sound effect signal that cause the speaker to output the sound effect; and
outputting the sound effect signal generated in the generating to the speaker,
wherein in a case where it is determined in the determining that the launch control is in preparation, the sound effect signal that causes the speaker to output a first sound effect having a component of a first frequency as a principal component is generated in the generating.
